(19) United States
(12) Patent Application Publication
(10) Pub. No.: US 2007/0022738 A1
(43) Pub. Date: Feb. 1, 2007

(54) Reinforcement rings for a tip turbine engine fan-turbine rotor assembly

(75) Inventors: James W. Norris, Lebanon, CT (US); Craig A. Nordeen, Manchester, CT (US); Gary Roberge, Tolland, CT (US); Brian Merry, Andover, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/190,450

(22) Filed: Jul. 27, 2005

(51) Int. Cl. F02C 3/04

(52) U.S. Cl. 60/226.1; 60/39.43

(57) ABSTRACT

A fan-turbine rotor assembly includes a diffuser mountable to the outer periphery of a multitude of fan blade sections to provide structural support to the outer tips of the fan blade sections and to turn and diffuse the airflow from the radial core airflow passage toward an axial airflow direction. The diffuser includes a fan blade tip shroud inner portion which forms a planar ring about the multiple of fan blade sections. Diffuser support rings are mounted to the fan blade tip shroud to further share the radial load applied to the fan blade sections by the blade mounted diffuser and annular turbine.

### BACKGROUND OF THE INVENTION

The present invention relates to a gas turbine engine, and more particularly to the attachment of a diffuser and tip turbine ring rotor upon a bypass fan of a tip turbine engine.

An aircraft gas turbine engine of the conventional turbofan type generally includes a forward bypass fan a compressor, a combustor, and an aft turbine all located along a common longitudinal axis. A compressor and a turbine of the engine are interconnected by a shaft. The compressor is rotatably driven to compress air entering the combustor to a relatively high pressure. This pressurized air is then mixed with fuel in a combustor and ignited to form a high energy gas stream. The gas stream flows axially aft to rotatably drive the turbine which rotatably drives the compressor through the shaft. The gas stream is also responsible for rotating the bypass fan. In some instances, there are multiple shafts or spools. In such instances, there is a separate turbine connected to a separate corresponding compressor through each shaft. In most instances, the lowest pressure turbine will drive the bypass fan.

Although highly efficient, conventional turbofan engines operate in an axial flow relationship. The axial flow relationship results in a relatively complicated elongated engine structure of considerable longitudinal length relative to the engine diameter. This elongated shape may complicate or prevent packaging of the engine into particular applications.

A recent development in gas turbine engines is the tip turbine engine. Tip turbine engines locate an axial compressor forward of a bypass fan which includes hollow fan blades that receive airflow from the axial compressor therethrough such that the hollow fan blades operate as a centrifugal compressor. Compressed core airflow from the hollow fan blades is mixed with fuel in an annular combustor and ignited to form a high energy gas stream which drives the turbine integrated onto the tips of the hollow bypass fan blades for rotation therewith as generally disclosed in U.S. Patent Application Publication Nos.: 20030192303; 20030192304; and 20040025490.

The tip turbine engine provides a thrust to weight ratio equivalent to conventional turbofan engines of the same class within a package of significantly shorter length.

The tip turbine engine utilizes a fan-turbine rotor assembly which integrates a diffuser assembly and a turbine onto the outer periphery of the bypass fan. Integrating the diffuser and turbine onto the tips of the hollow bypass fan blades provides an engine design challenge.

Accordingly, it is desirable to provide a diffuser and turbine for a fan-turbine rotor assembly, which is readily manufactured and mountable to the outer periphery of a bypass fan.

### SUMMARY OF THE INVENTION

The fan-turbine rotor assembly according to the present invention includes a diffuser mountable to the outer periphery of a multitude of fan blade sections to provide structural support to the outer tips of the fan blade sections and to turn and diffuse the airflow from the radial core airflow passage toward an axial airflow direction.

The diffuser includes a fan blade tip shroud inner portion which forms a planar ring about the multiple of fan blade sections. The fan blade tip shroud includes a multiple of blade tip receipt sections to radially retain the fan blade tips. The blade tip receipt sections slide onto the tip of each fan blade section in a uni-directional manner from the rear face of the fan hub. The radial engagement member engages the blade tip receipt section of the fan-turbine rotor assembly to provide a directional lock therebetween during operation.

Diffuser support rings are mounted around the fan blade tip shroud. The diffuser support rings are rings of high strength material such as a wound composite ring which share the radial load applied to the fan blade sections by the diffuser and the attached turbine. The diffuser support rings are attached forward and aft of the diffuser in a radial uni-directional manner such that rotation of the fan-turbine rotor assembly during operation provides a directional lock thereto.

The present invention therefore provides a diffuser and turbine for a fan-turbine rotor assembly that is readily manufactured and mountable to the outer periphery of a bypass fan.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a partial sectional perspective view of a tip turbine engine;

FIG. 2 is a longitudinal sectional view of a tip turbine engine along an engine centerline;

FIG. 3 is an exploded view of a fan-turbine rotor assembly;

FIG. 4 is an expanded partial perspective view of a fan-turbine rotor assembly;

FIG. 5 is an expanded perspective view of a separate inducer for the fan-turbine rotor assembly;

FIG. 6 is an expanded perspective view of the fan-turbine rotor assembly illustrating the overlapped inducer arrangement;

FIG. 7A is a perspective partial phantom view of a single rotor blade mounted within a rotor hub;

FIG. 7B is a perspective partial sectional view of a single rotor blade mounted within a rotor hub;

FIG. 8 is an exploded view of a rotor hub, diffuser and diffuser support ring prior to attachment to respective fan blade sections;

FIG. 9A is a perspective exploded view of a diffuser fan blade tip shroud inner portion prior to mounting to a fan blade section;

FIG. 9B is a side phantom view of a fan blade section prior to slidably mounting of an annular diffuser and attached turbine;

FIG. 9C is a front sectional view a fan blade tip section mounted into diffuser fan blade tip shroud inner portion;

FIG. 9D is a side phantom view of the annular diffuser and attached turbine mounted to the fan blade section;

FIG. 9E is a perspective view of the annular diffuser, attached turbine and diffuser support ring mounted to the fan blade section;

FIG. 9F is a exploded perspective view illustrating attachment of the diffuser support ring to the annular diffuser;

FIG. 10A is an expanded exploded view of a segmented turbine rotor ring;

FIG. 10B is an expanded front view of a turbine rotor ring;

FIG. 11A is an expanded perspective view of a segment of a first stage turbine rotor ring;

FIG. 11B is an expanded perspective view of a segment of a second stage turbine rotor ring;

FIG. 12 is a side planar view of a turbine mounted to the diffuser for a tip turbine engine;

FIG. 13 is an expanded perspective view of a first stage and a second stage turbine rotor ring mounted to a diffuser ring of a fan-turbine rotor assembly;

FIG. 14A is an expanded perspective view of a first stage and a second stage turbine rotor ring in a first mounting position relative to a diffuser ring of a fan-turbine rotor assembly;

FIG. 14B is an expanded perspective view of a first stage and a second stage turbine rotor ring illustrating turbine torque load surface on each turbine rotor ring;

FIG. 14C is an expanded perspective view of a first stage and a second stage turbine rotor ring illustrating the anti-back out tabs and anti-back out slots to lock the first stage and a second stage turbine rotor ring; and

FIG. 14D is a side sectional view of a first stage and a second stage turbine rotor ring illustrating the interaction of the turbine torque load surfaces and adjacent stops; and

### DETAILED DESCRIPTION OF THE PREFERRED EMBODIMENT

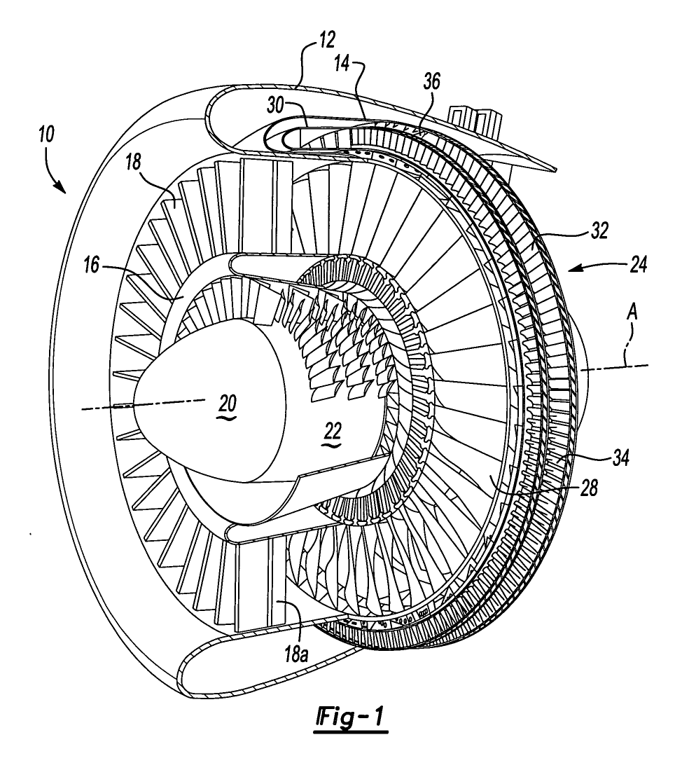

FIG. 1 illustrates a general perspective partial sectional view of a tip turbine engine type gas turbine engine 10. The engine 10 includes an outer nacelle 12, a nonrotatable static outer support structure 14 and a nonrotatable static inner support structure 16. A multitude of fan inlet guide vanes 18 are mounted between the static outer support structure 14 and the static inner support structure 16. Each inlet guide vane preferably includes a variable trailing edge 18A.

A nose cone 20 is preferably located along the engine centerline A to smoothly direct airflow into an axial compressor 22 adjacent thereto. The axial compressor 22 is mounted about the engine centerline A behind the nose cone 20.

A fan-turbine rotor assembly 24 is mounted for rotation about the engine centerline A aft of the axial compressor 22. The fan-turbine rotor assembly 24 includes a multitude of hollow fan blades 28. The hollow fan blades 28 communicate this compressed air from the axial compressor 22 to an annular combustor 30. The hollow fan blades 28 provide internal, centrifugal compression of the compressed airflow to increase compression of the airflow for distribution to the annular combustor 30 located within the nonrotatable static outer support structure 14.

A turbine 32 includes a multitude of tip turbine blades 34 (two stages shown) which rotatably drive the hollow fan blades 28 relative to a multitude of tip turbine stators 36 which extend radially inwardly from the static outer support structure 14. The annular combustor 30 is axially forward of the turbine 32 and communicates with the turbine 32.

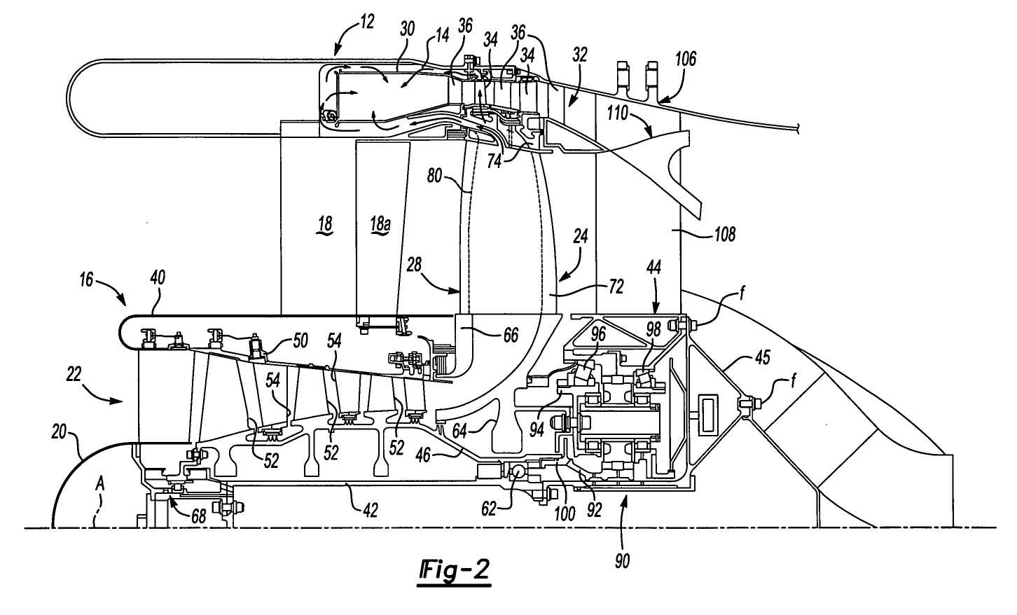

Referring to FIG. 2, the nonrotatable static inner support structure 16 includes a splitter 40, a static inner support housing 42 and a static outer support housing 44 located coaxial to said engine centerline A.

The axial compressor 22 includes the axial compressor rotor 46 from which a plurality of compressor blades 52 extend radially outwardly and a compressor case 50 fixedly mounted to the splitter 40. A plurality of compressor vanes 54 extend radially inwardly from the compressor case 50 between stages of the compressor blades 52. The compressor blades 52 and compressor vanes 54 are arranged circumferentially about the axial compressor rotor 46 in stages (three stages of compressor blades 52 and compressor vanes 54 are shown in this example). The axial compressor rotor 46 is mounted for rotation upon the static inner support housing 42 through a forward bearing assembly 68 and an aft bearing assembly 62.

The fan-turbine rotor assembly 24 includes a fan hub 64 that supports a multitude of the hollow fan blades 28. Each fan blade 28 includes an inducer section 66, a hollow fan blade section 72 and a diffuser section 74. The inducer section 66 receives airflow from the axial compressor 22 generally parallel to the engine centerline A and turns the airflow from an axial airflow direction toward a radial airflow direction. The airflow is radially communicated through a core airflow passage 80 within the fan blade section 72 where the airflow is centrifugally compressed. From the core airflow passage 80, the airflow is turned and diffused by the diffuser section 74 toward an axial airflow direction toward the annular combustor 30. Preferably the airflow is diffused axially forward in the engine 10, however, the airflow may alternatively be communicated in another direction.

A gearbox assembly 90 aft of the fan-turbine rotor assembly 24 provides a speed increase between the fan-turbine rotor assembly 24 and the axial compressor 22. Alternatively, the gearbox assembly 90 could provide a speed decrease between the fan-turbine rotor assembly 24 and the axial compressor rotor 46. The gearbox assembly 90 is mounted for rotation between the static inner support housing 42 and the static outer support housing 44. The gearbox assembly 90 includes a sun gear shaft 92 which rotates with the axial compressor 22 and a planet carrier 94 which rotates with the fan-turbine rotor assembly 24 to provide a speed differential therebetween. The gearbox assembly 90 is preferably a planetary gearbox that provides co-rotating or counter-rotating rotational engagement between the fan-turbine rotor assembly 24 and an axial compressor rotor 46. The gearbox assembly 90 is mounted for rotation between the sun gear shaft 92 and the static outer support housing 44 through a forward bearing 96 and a rear bearing 98. The forward bearing 96 and the rear bearing 98 are both tapered roller bearings and both handle radial loads. The forward bearing 96 handles the aft axial loads while the rear bearing 98 handles the forward axial loads. The sun gear shaft 92 is rotationally engaged with the axial compressor rotor 46 at a splined interconnection 100 or the like.

In operation, air enters the axial compressor 22, where it is compressed by the three stages of the compressor blades 52 and compressor vanes 54. The compressed air from the axial compressor 22 enters the inducer section 66 in a direction generally parallel to the engine centerline A and is turned by the inducer section 66 radially outwardly through the core airflow passage 80 of the hollow fan blades 28. The airflow is further compressed centrifugally in the core airflow passage 80 of the hollow fan blades 28 by rotation of the hollow fan blades 28. From the core airflow passage 80, the airflow is turned and diffused axially forward in the engine 10 into the annular combustor 30. The compressed core airflow from the hollow fan blades 28 is mixed with fuel in the annular combustor 30 and ignited to form a high-energy gas stream. The high-energy gas stream is expanded over the multitude of tip turbine blades 34 mounted about the outer periphery of the fan blades 28 to drive the fan-turbine rotor assembly 24, which in turn drives the axial compressor 22 through the gearbox assembly 90. Concurrent therewith, the fan-turbine rotor assembly 24 discharges fan bypass air axially aft to merge with the core airflow from the turbine 32 in an exhaust case 106. A multitude of exit guide vanes 108 are located between the static outer support housing 44 and the nonrotatable static outer support structure 14 to guide the combined airflow out of the engine 10 to provide forward thrust. An exhaust mixer 110 mixes the airflow from the turbine blades 34 with the bypass airflow through the fan blades 28.

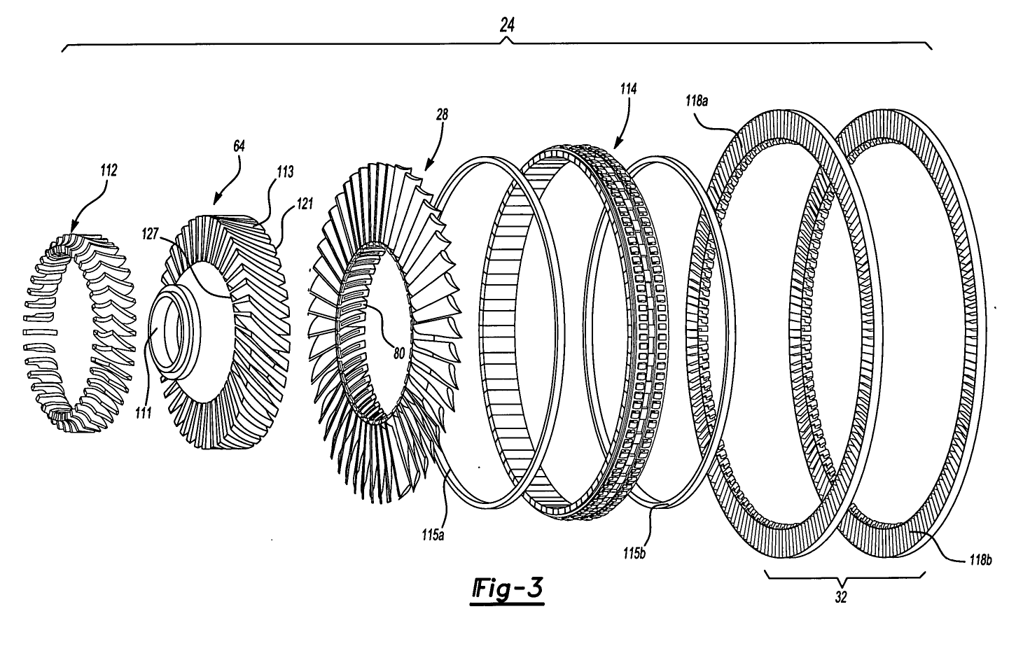

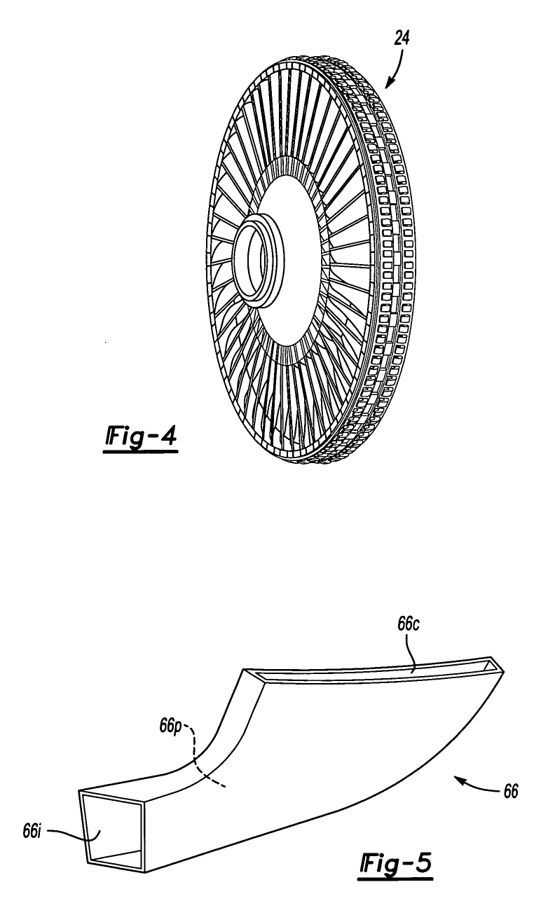

Referring to FIG. 3, the fan-turbine rotor assembly 24 is illustrated in an exploded view. The fan hub 64 is the primary structural support of the fan-turbine rotor assembly 24 (also illustrated assembled in FIG. 4). The fan hub 64 supports an inducer 112, the multitude of fan blades 28, a diffuser 114, a forward and aft diffuser support ring 115a, 115b, and the annular turbine 32.

The fan hub 64 is preferably forged and then milled to provide the desired geometry. The fan hub 64 defines a bore 111 and an outer periphery 113. The outer periphery 113 is preferably scalloped by a multitude of elongated openings 121 located about the outer periphery 113.

Each elongated opening 121 defines an inducer receipt section 127 to receive each inducer section 66. The inducer receipt section 127 generally follows the shape of the inducer section 66. That is, the inducer receipt section 127 receives the more complicated shape of the inducer section 66 without the necessity of milling the more complicated shape directly into the fan hub 64 itself.

The inducer sections 66 are essentially conduits that define an inducer passage 66p between an inducer inlet 66i and an inducer exit 66e (also illustrated in FIG. 5). Preferably, the inducer sections 66 are formed of a composite material.

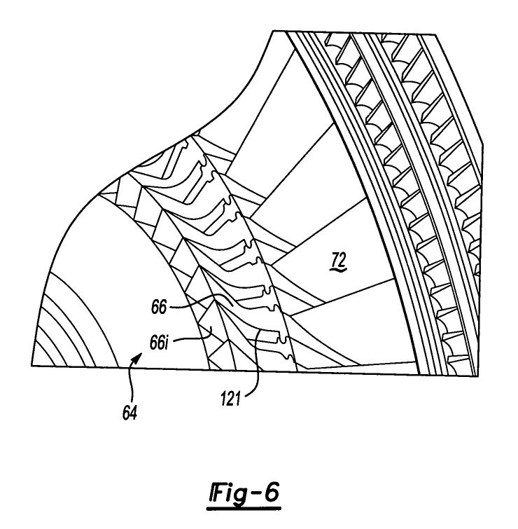

The inducer sections 66 together form the inducer 112 of the fan-turbine rotor assembly 24. The inducer inlet 66i of each inducer passage 66p extends forward of the fan hub 64 and is canted toward a rotational direction of the fan hub 64 such that inducer inlet 66i operates as an air scoop during rotation of the fan-turbine rotor assembly 24 (FIG. 6). Each inducer passage 66p provides separate airflow communication to each core airflow passage 80 when each fan blade section 72 is mounted within each elongated opening 121.

Inducer sections 66 are preferably uni-directionally assembled into the fan hub 64 from the front such that the forces exerted upon the fan-turbine rotor assembly 24 during operation correspond with further locking of the inducer sections 66 into the fan hub 64. Each inducer inlet 66i preferably at least partially overlaps the next inducer inlet 66i when assembled into the fan hub 64 (FIG. 6). The overlapped orientation the inducer inlets 66i lock the inducer sections 66 into the fan hub 64. That is, operational forces maintain the inducer sections 66 within the fan hub 64 in an assembled condition rather than operating to disassemble the components. Alternatively, or in addition the inducer sections 66 may be mounted to the fan hub 64 through an attachment such as bonding, welding, rivets, threaded fasteners, and the like.

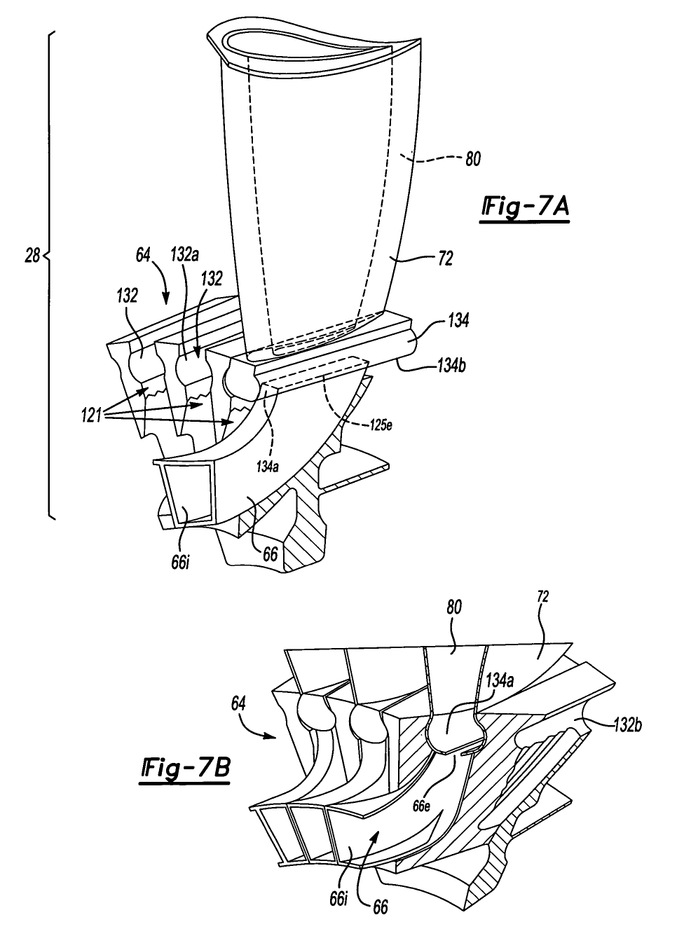

Referring to FIG. 7A, the fan hub 64 retains each hollow fan blade section 72 within each elongated opening 121 through a blade receipt section 132. The blade receipt section 132 preferably forms an axial semi-cylindrical opening formed along the axial length of the elongated openings 121. It should be understood that other retention structures will likewise be usable with the present invention.

Each hollow fan blade section 72 includes an inner fan blade mount 134 that corresponds to the blade receipt section 132 to retain the hollow fan blade section 72 within the fan hub 64. The inner fan blade mount 134 preferably includes a semi-cylindrical portion to radially retain the fan blade 28. A dove-tail, fir-tree, bulb-type, or other radial engagement structure will also be usable with the present invention. The fan hub 64 supports the hoop load required to retain the integrity of the disk/blade structure.

The inner fan blade mount 134 is preferably uni-directionally mounted into the blade receipt section 132 from the rear face of the fan hub 64. The inner fan blade mount 134 engages the blade receipt section 132 during operation of the fan-turbine rotor assembly 24 to provide a directional lock therebetween. That is, the inner fan blade mount 134 and the blade receipt section 132 may be frustoconical or axially non-symmetrical such that the forward segments 132a, 134a form a smaller engagement surface than the rear segment 132b, 134b (FIG. 7B) to provide a wedged engagement therebetween when in operation.

Each inducer section 66 is retained within the fan hub 64 by interaction with the inner fan blade mount 134. The inner fan blade mount 134 engages the inducer exit 66e to further retain the inducer sections 66 into the fan hub 64 to provide core airflow communication from the inducer passages 66p into the core airflow passage 80.

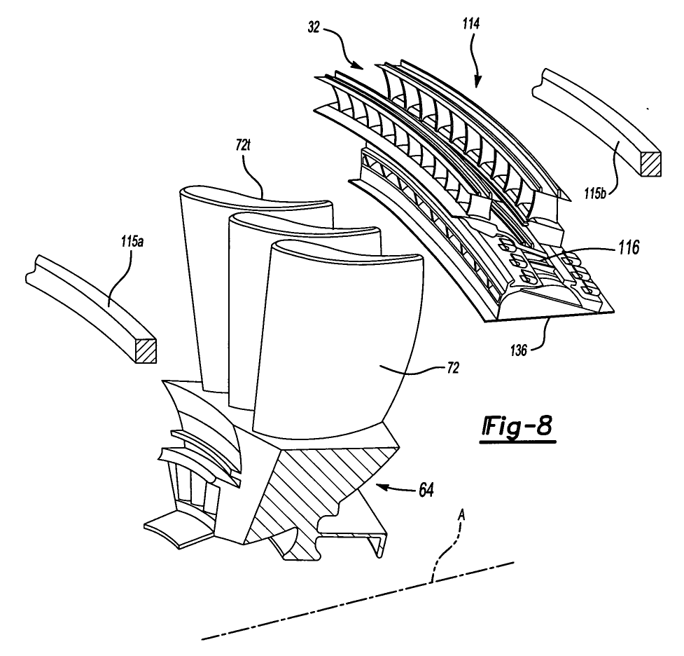

Referring to FIG. 8, the diffuser 114 is preferably a ring which defines a diffuser outer surface 116. The diffuser 114 is mountable to the outer periphery of the fan blade sections 72 to provide structural support to the fan blade tip sections 72T of the fan blade sections 72 and to turn and diffuse the airflow from the radial core airflow passage 80 toward an axial airflow direction.

Alternatively, the diffuser 114 may be separated into diffuser sections which are separately mounted to each fan blade tip section 72T such that the annular diffuser 114 is formed into a ring when the fan-turbine rotor 24 is assembled. It should be understood, however, that the fan-turbine rotor assembly 24 may be formed in various ways including casting multitude sections as integral components, individually manufacturing and assembling individually manufactured components, and/or other combinations thereof.

The diffuser 114 preferably includes a fan blade tip shroud 136 inner periphery which forms a planar ring about the multiple of fan blade sections 72. That is, the fan blade tip shroud 136 is a base about the outer diameter of the fan blade sections 72 which supports the diffuser 114. The fan blade tip shroud 136 may be separate or integral with the diffuser 114 to at least partially resist the radial load of the fan blade sections 72.

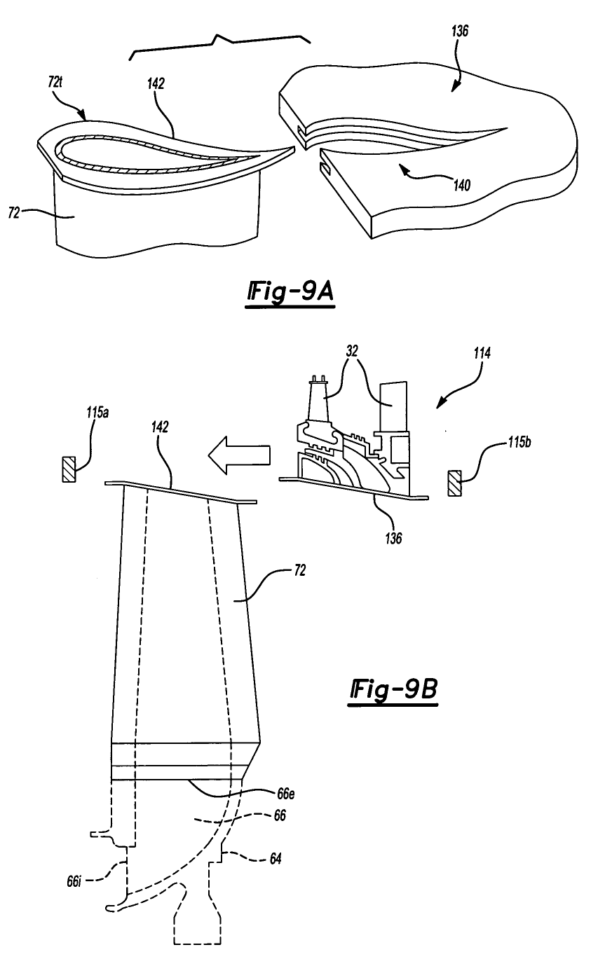

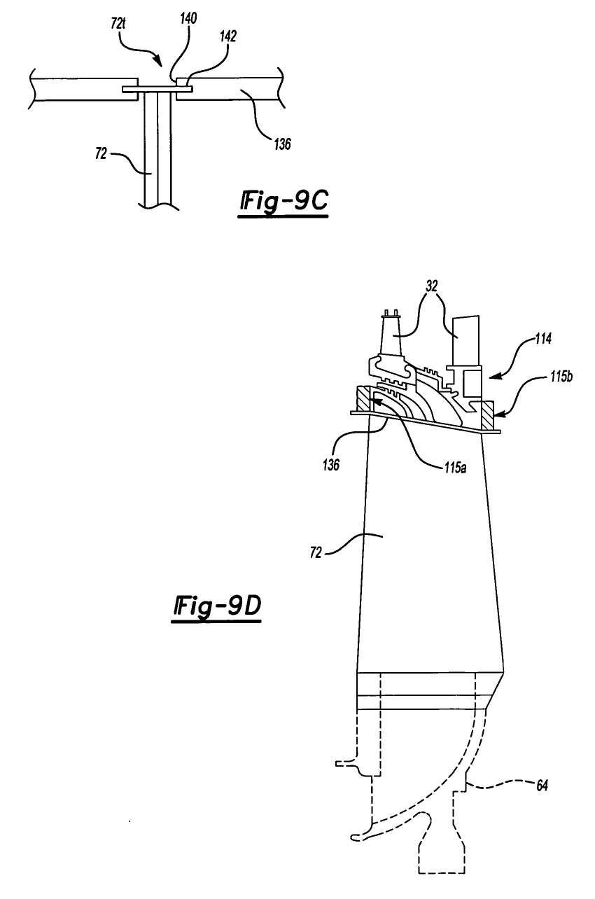

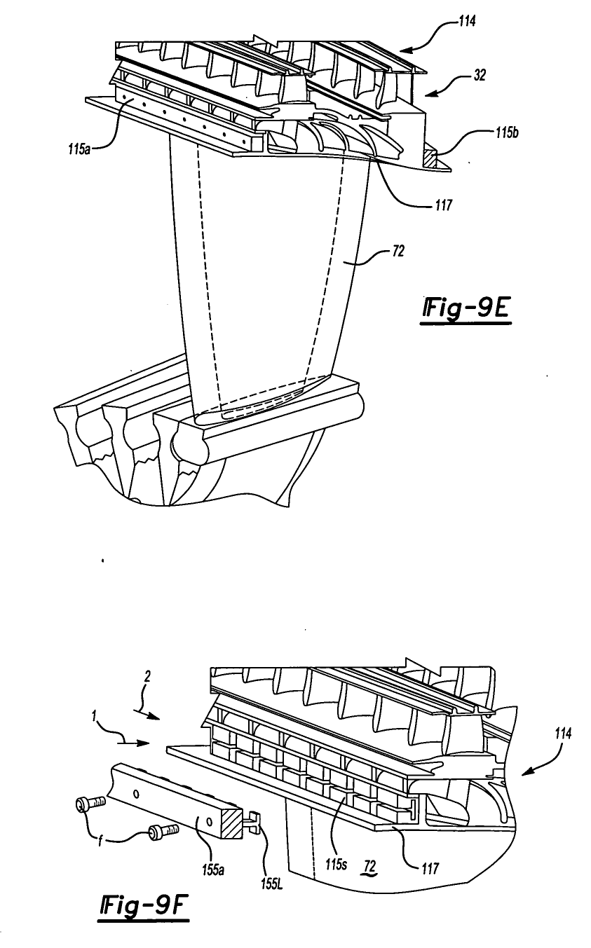

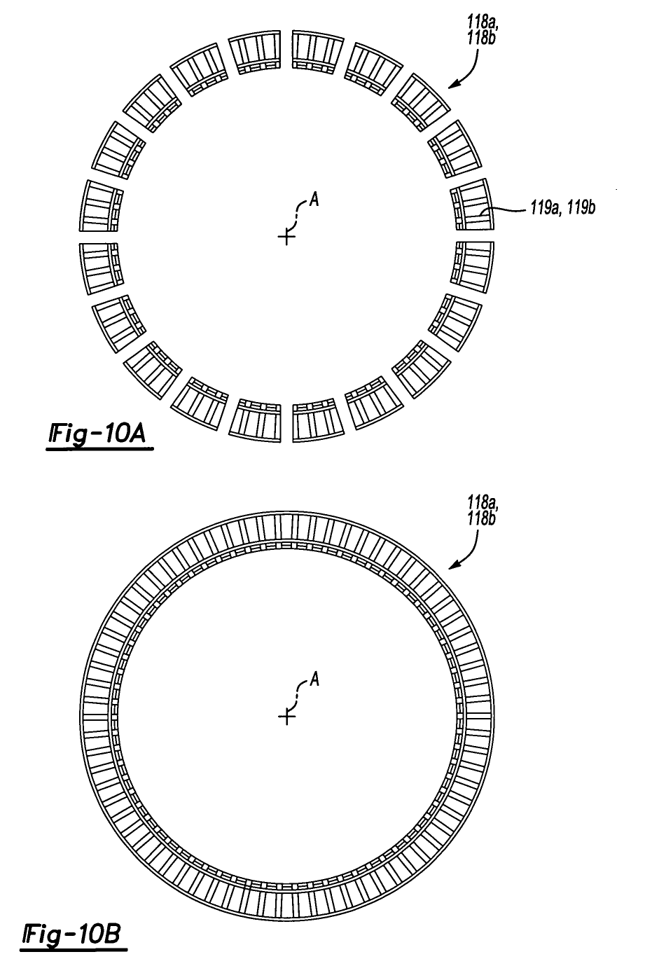

The fan blade tip shroud 136 includes a multiple of blade tip receipt sections 140 (FIG. 9A). The blade tip receipt sections 140 preferably correspond in shape with the fan blade tip sections 72T. In other words, the blade tip receipt sections 140 generally follow the airfoil shape of the fan blade sections 72. Each fan blade tip 72T includes a radial engagement member 142 to radially retain the fan blade sections 72 to the diffuser 114. The blade tip receipt sections 140 preferably slide onto the fan blade tip 72T of each fan blade section 72 (FIG. 9C) in a uni-directional manner from the rear face of the fan hub 64. The radial engagement member 142 engages the blade tip receipt section 140 (FIG. 9C) during operation of the fan-turbine rotor assembly 24 to provide a directional lock therebetween. It should be understood that other retention structures will likewise be usable with the present invention.

Referring to FIG. 9D, the diffuser support rings 115a, 115b are mounted around the fan blade tip shroud 136. The diffuser support rings 115a, 155b are preferably rings of high strength material such as a wound composite ring which is attached forward and aft of the diffuser 114 (also illustrated in FIG. 9E). The diffuser support rings 115a, 115b share the radial load applied to the fan blade sections by the diffuser 114 and the turbine 32. The diffuser support rings 115a, 115b are attached to the diffuser 114 in a radial uni-directional manner such that rotation of the fan-turbine rotor assembly 24 provides a directional lock thereto.

Referring to FIG. 9F, a multitude of segmented circumferential lugs 115L preferably extend from the diffuser support rings 115a, 115b to engage corresponding segmented circumferential slots 115S on the diffuser 114. The diffuser support rings 115a, 115b are installed by first aligning the lugs 115L with openings in the slots 115S (as indicated by arrow 1) then rotating the diffuser support rings 115a, 115b (as indicated by arrow 2) to engage the lugs 115L with the slots 115S.

Radial stops preferably lock the diffuser support rings 115a, 115b in engagement therewith. The stops are located in opposition to the direction of rotation of the fan rotor assembly to maintain the diffuser support rings 115a, 115b in contact with the stops. Notably, the lugs 115L and slots 115S only locate the diffuser support rings 115a, 115b around the fan blade tip shroud 136. The diffuser support rings 115a, 115b retain the diffuser 114 and annular turbine 32 due to the ring structure itself and thereby share the outward radial loads of the diffuser 114. Fasteners F may additionally be utilized to removably attach the diffuser support ring 115a, 115b to the diffuser 114. It should be understood that other removable retention arrangements and locking members will likewise be usable with the present invention.

Referring to FIG. 10A, the turbine 32 is formed as one or more turbine ring rotors 118a, 118b which include a multitude of turbine blade clusters 119a, 119b. Installation of the multitude of the turbine blade clusters 119a, 119b respectively form the turbine ring rotor 118a, 118b defined about the engine centerline A. By forming the turbine 32 as a multitude of clusters, leakage between adjacent blade platforms is minimized which increases engine efficiency. Manufacturing and assembly is also readily facilitated considering the casting detail level involved. Another advantage is that by forming the turbine 32 as a multitude of clusters 119a, 119b the turbine hoop load path is broken. Breaking the turbine hoop load path reduces the thermal contrast between the turbine blade clusters 119a, 119b and the diffuser 114. Alternatively, the turbine ring rotors 118a, 118b may be cast directly to the diffuser section.

As discussed herein, the turbine ring rotor 118a is a first stage of the turbine 32, and turbine ring rotor 118b is a second stage of the turbine 32, however, other turbine stages will likewise benefit from the present invention. Furthermore, gas turbine engines other than tip turbine engines will also benefit from the present invention.

Alternatively, each turbine ring rotor 118a′, 118b′may be cast as a single integral annular ring cluster (FIG. 10B) defined about the engine centerline A. By forming the turbine 32 as one or more rings, leakage between adjacent blade platforms is minimized which increases engine efficiency.

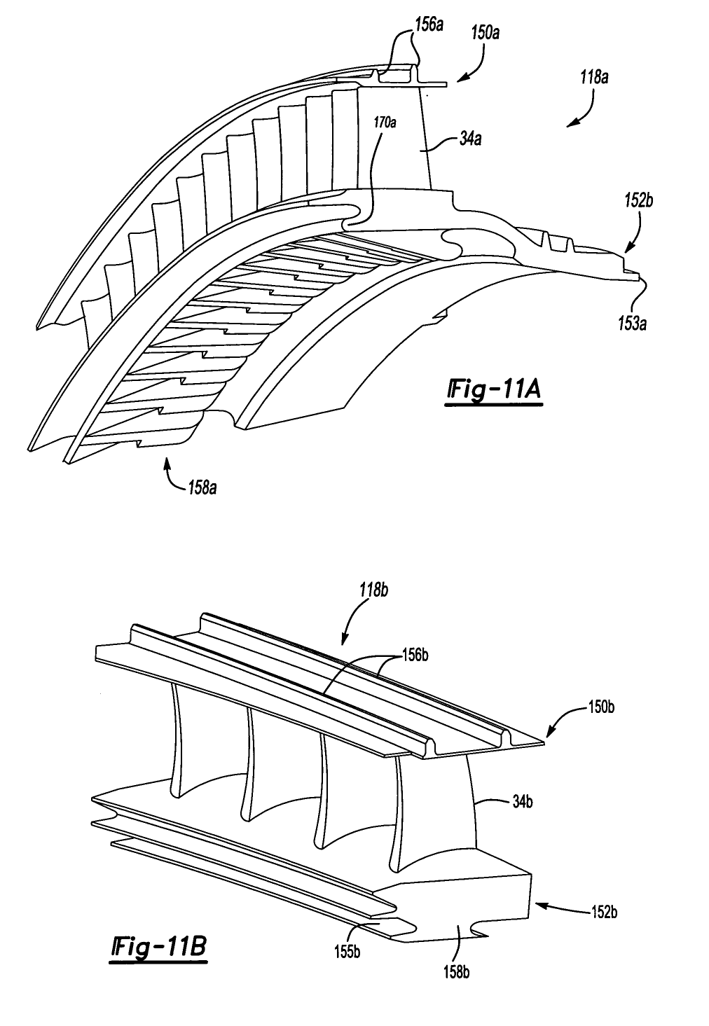

Referring to FIGS. 11A and 11B, each turbine blade cluster 119a, 119b includes an arcuate tip shroud 150a, 150b, an arcuate base 152a, 152b and a multitude of turbine blades 34a, 34b mounted between the arcuate tip shroud 150a, 150b and the arcuate base 152a, 152b, respectively. The arcuate tip shroud 150a, 150b and the arcuate base 152a, 152b are generally planar rings defined about the engine centerline A. The arcuate tip shroud 150a, 150b and the arcuate base 152a, 152b provide support and rigidity to the multitude of turbine blades 34a, 34b.

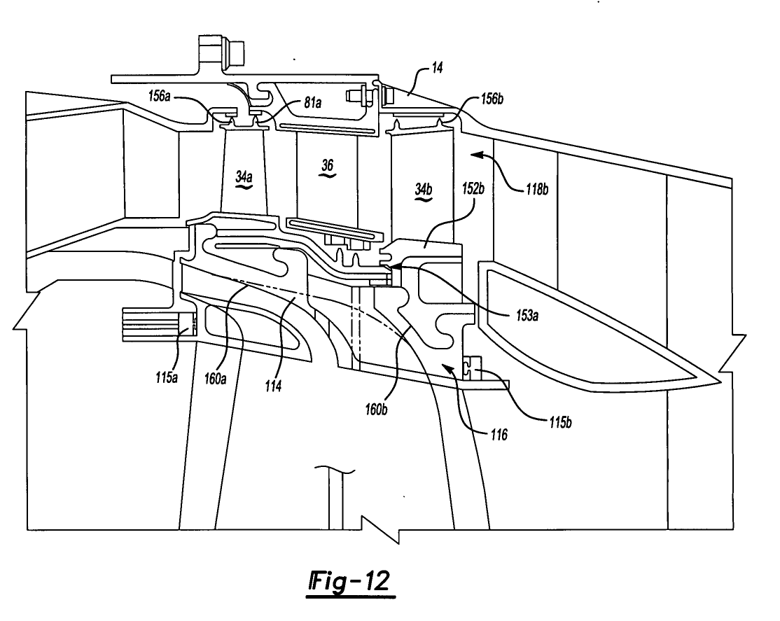

The arcuate tip shroud 150a, 150b each include a tip seal 156a, 156b extending therefrom. The tip seal 156a, 156b preferably extend perpendicular to the arcuate tip shroud 150a, 150b to provide a knife edge seal between the turbine ring rotor 118a, 118b and the nonrotatable static outer support structure 14 (also illustrated in FIG. 12). It should be understood that other seals may alternatively or additionally be utilized.

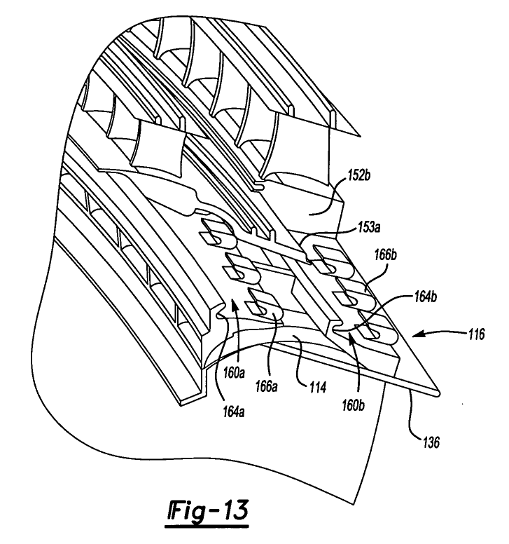

The arcuate base 152a, 152b includes attachment lugs 158a, 158b. The attachment lugs 158a, 158b are preferably segmented to provide installation by axial mounting and radial engagement of the turbine ring rotor 118a, 118b to the diffuser surface 116 as will be further described. The attachment lugs 158a, 158b preferably engage a segmented attachment slot 160a, 160b formed in the diffuser surface 116 in a dovetail-type, bulb-type or fir tree-type engagement. The segmented attachment slots 160a, 160b are formed into the diffuser surface 116. The segmented attachment slots 160a, 160b preferably include a continuous forward slot surface 164a, 164b and a segmented aft slot surface 166a, 166b (FIG. 13).

The arcuate base 152a preferably provides an extended axial stepped ledge 153a which engages a seal surface 125b which extends from the arcuate base 152b. That is, arcuate bases 152a, 152b provide cooperating surfaces to seal an outer surface of the diffuser surface 116 (FIG. 8).

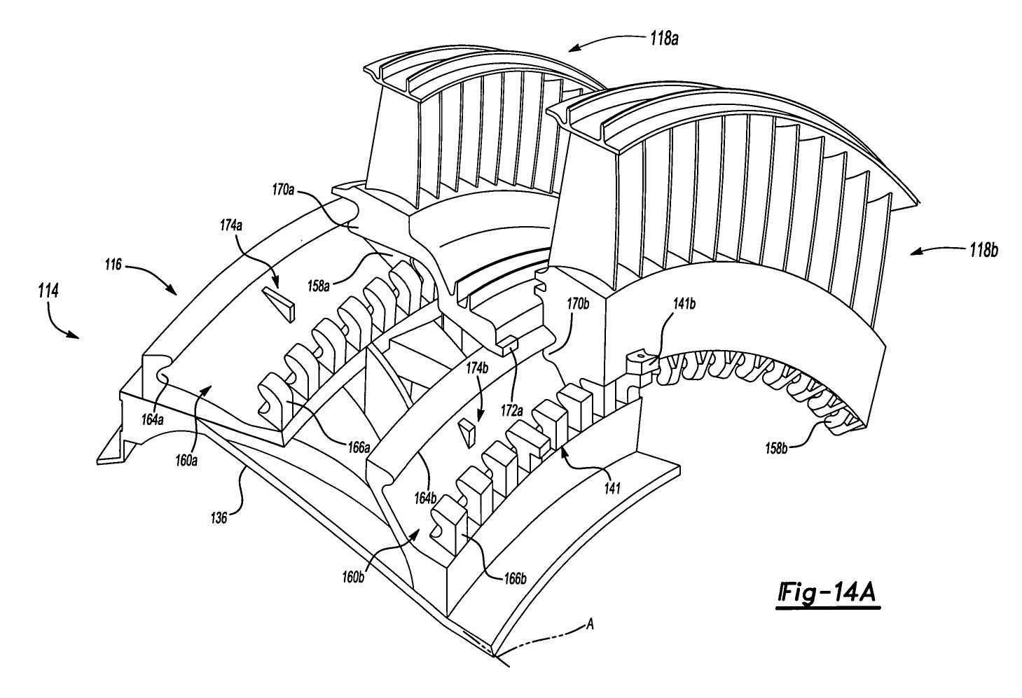

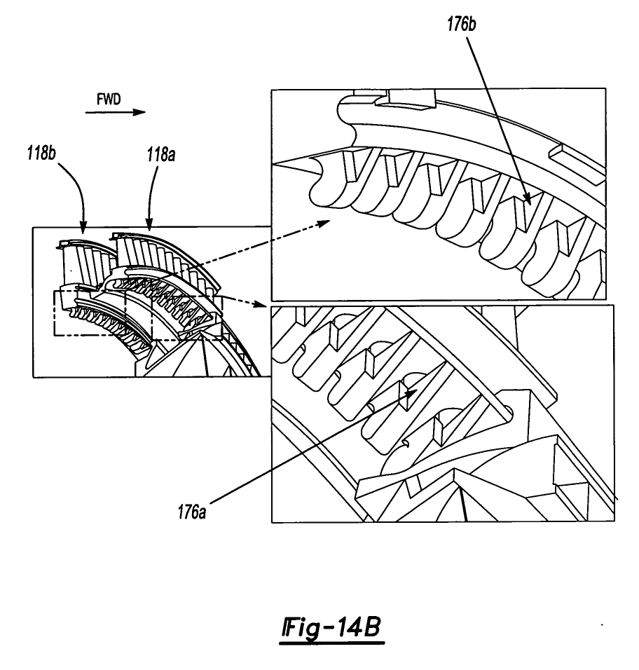

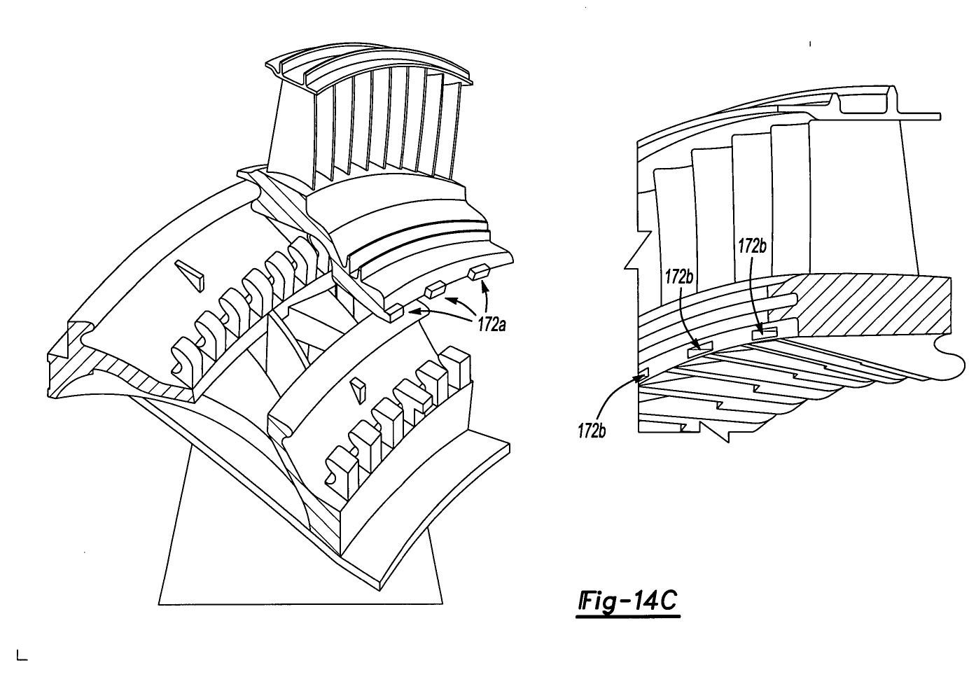

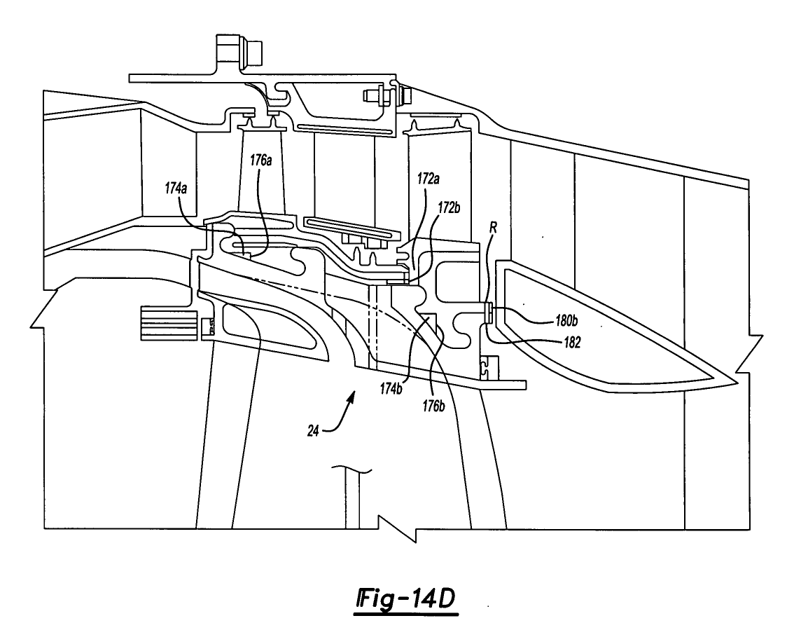

Referring to FIG. 14A, assembly of the turbine 32 to the diffuser surface 116 will be describe with reference to the turbine ring rotors 118a, 118b which include a multitude of separate turbine blade clusters 119a, 119b (FIG. 6A). Assembly of the blade clusters 119a, 119b to the diffuser surface 116, begins with one of the first stage turbine blade cluster 119a which are first axially mounted from the rear of the diffuser surface 116. The forward attachment lug engagement surface 170a is engaged with the continuous forward slot engagement surface 164a by passing the attachment lugs 158a through the segmented aft slot surface 156a. That is, the attachment lugs 158a are aligned to slide through the lugs of the segmented aft slot surface 166a. All first stage clusters 119a are then installed in this fashion. Next, one of the second stage blade clusters 119b is axially mounted from the rear of the diffuser surface 116. The forward attachment lug engagement surface 170b is engaged with the continuous forward slot engagement surface 164b by passing the attachment lugs 158b through the segmented aft slot surface 166b. That is, the attachment lugs 158b are aligned to slide between the lugs of the segmented aft slot surface 166b.

The extended axial stepped ledge 153a of the arcuate base 152a receives the seal surface 155b of the arcuate base 152b. The second stage turbine blade cluster 119b rotationally locks with the first stage turbine blade cluster 119a through engagement between anti-backout tabs 172a and anti-backout slots 172b (also illustrated in FIG. 14C). The remaining second stage airfoil clusters 119b are installed in the same manner.

A multitude of radial stops 174a, 174b are located upon the diffuser surface 116 to correspond with each of the turbine blade clusters 119a, 119b. Once all of the pairs of clusters 119a, 119b are installed the turbine ring rotors 118a, 118b are completed. The turbine ring rotors 118a, 118b are then rotated as a unit within the segmented attachment slot 160a, 160b so that a torque load surface 176a, 176b (FIGS. 14B-14C) on each turbine cluster 119a, 119b contacts a radial stop 174a, 174b to radially locate the attachment lugs 158a, 158b adjacent the lugs of the segmented aft slot surface 166a, 166b of the segmented attachment slots 160a, 160b.

Preferably, the completed turbine ring rotors 118a, 118b are rotated together toward the radial stops 174a, 174b in a direction which will maintain the turbine ring rotors 118a, 118b against the radial stops 174a, 174b during operation. It should be understood that a multitude of torque load surface 176a, 176b and radial stop 174a, 174b may be located about the periphery of the diffuser surface 116 to restrict each turbine blade cluster 119a, 119b. It should be further understood that other locking arrangements may also be utilized.

Once the turbine ring rotors 118a, 118b are rotated, a second stage turbine ring anti-backout retainer tab 180b which extends from each of the second stage blade clusters 119b is aligned with an associated anti-backout retainer tab 182 which extends from the diffuser surface 116 (FIG. 14D). A multitude of anti-backout retainer tabs 182 are located about the diffuser surface 116 to correspond with each of the turbine blade clusters 119b. The turbine ring anti-backout retainer tabs 180b and the anti-backout retainer tabs 182 are locked together through a retainer R such as screws, peening, locking wires, pins, keys, and/or plates as generally known. The turbine ring rotors 118a, 118b are thereby locked radially together and mounted to the fan-turbine rotor assembly 24 (FIG. 14D).

It should be understood that relative positional terms such as “forward,” “aft,” “upper,” “lower,” “above,” “below,” and the like are with reference to the normal operational attitude of the vehicle and should not be considered otherwise limiting.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A fan blade for a tip turbine engine comprising:
a fan blade section which defines a core airflow passage therethrough, said fan blade section defining a fan blade axis of rotation; and
a diffuser section mountable to said fan blade section, said diffuser section in communication with said core airflow passage to turn an airflow within said core airflow passage to an axial airflow direction.

2. The fan blade as recited in claim 1, wherein said fan blade includes a fan blade mount section.

3. The fan blade assembly as recited in claim 2, wherein said fan blade mount section defines a semi-cylindrical portion.

4. The fan blade as recited in claim 1, further comprising a turbine blade section which extends from said diffuser section, said turbine blade section including a multitude of turbine blades.

5. The fan blade assembly as recited in claim 1, further comprising an annular fan tip shroud mountable to said fan blade section, said diffuser section mounted to said annular fan tip shroud.

6. The fan blade assembly as recited in claim 5, further comprising a blade tip receipt section formed in said annular fan tip shroud to receive a tip of said fan blade section.

7. The fan blade assembly as recited in claim 5, further comprising a diffuser support ring mounted to said fan tip shroud and said diffuser section.

8. The fan blade assembly as recited in claim 1, further comprising a diffuser support ring mounted around said diffuser section.

9. A fan blade assembly for a tip turbine engine comprising:
a fan blade section which defines a core airflow passage therethrough;
a diffuser section mountable to said fan blade section, said diffuser section in communication with said core airflow passage to turn said airflow from said radial airflow direction to a second axial airflow direction, said diffuser section forming a segmented attachment slot; and
a turbine blade cluster mountable to said diffuser section, said turbine blade cluster having a multitude of turbine blades mounted between an arcuate tip shroud and an arcuate base, said arcuate base defining a segmented attachment lug engageable with said segmented attachment slot.

10. The fan blade assembly as recited in claim 9 wherein said segmented attachment slot forms a continuous forward slot engagement surface and a segmented aft slot surface.

11. The fan blade assembly as recited in claim 10, wherein said segmented attachment lug includes a forward attachment lug engagement surface engageable with said continuous forward slot engagement surface.

12. The fan blade assembly as recited in claim 9 wherein a multiple of said turbine blade clusters form a turbine ring rotor.

13. The fan blade assembly as recited in claim 12, furthering comprising a multiple of second stage turbine blade clusters which form a second stage turbine ring rotor engageable with said turbine ring rotor.

14. The fan blade assembly as recited in claim 9, further comprising an annular fan tip shroud section mounted to said fan blade section, said diffuser section mounted to said fan tip shroud section.

15. A fan hub assembly for a tip turbine engine comprising:
a fan hub defining a hub axis of rotation, said fan hub defining an elongated opening located about an outer periphery of said fan hub;
a fan blade section which defines a core airflow passage therethrough;
a fan blade mount section attached to said fan blade section, said fan blade mount section receivable within said elongated opening for retention therein;
a diffuser section mountable to said fan blade section, said diffuser section in communication with said core airflow passage to turn said airflow from said radial airflow direction to a second axial airflow direction, said diffuser section forming a segmented attachment slot; and
a turbine blade cluster mountable to said diffuser section, said turbine blade cluster having a multitude of turbine blades mounted between an arcuate tip shroud and an arcuate base, said arcuate base defining a segmented attachment lug engageable with said segmented attachment slot.

16. The fan hub assembly as recited in claim 15, wherein said diffuser section is an annular diffuser ring.

17. The fan hub assembly as recited in claim 15, further comprising an annular fan tip shroud section mounted to said fan blade section, said diffuser section mountable to said fan tip shroud section.

18. The fan hub assembly as recited in claim 17, further comprising a diffuser support ring mounted to said diffuser section.

19. The fan hub assembly as recited in claim 15, further comprising a diffuser support ring mounted to said diffuser section.

20. The fan hub as recited in claim 15, wherein said diffuser section and said turbine blade section are formed as a single component.
